(19) United States
(12) Patent Application Publication
(10) Pub. No.: US 2021/0402504 A1
(43) Pub. Date: Dec. 30, 2021

(54) TORSIONAL DAMPER AND METHOD OF WELDING PARTS HAVING DISSIMILAR MATERIALS

(71) Applicant: GM GLOBAL TECHNOLOGY OPERATIONS LLC, DETROIT, MI (US)

(72) Inventors: Daniel J. Wilson, Linden, MI (US); Huaxin Li, Rochester Hills, MI (US); James D. Cremonesi, ROCHESTER HILLS, MI (US); Jianghuai Yang, Rochester Hills, MI (US); Liang Wang, Rochester Hills, MI (US); Qigui Wang, ROCHESTER HILLS (US)

(21) Appl. No.: 16/913,406

(22) Filed: Jun. 26, 2020

(51) Int. Cl. B23K 20/12; B23K 20/227; B23K 20/02

(52) U.S. Cl. CPC B23K 20/129; B23K 2101/006; B23K 20/02; B23K 20/2275

(57) ABSTRACT

A method of joining first and second parts formed of dissimilar materials is provided. The first part defines a first part contacting surface having a frustoconical shape. The first and second parts are brought into contact with one another, with one of the first and second parts being rotated while the other remains stationary, so as to generate frictional heat between the contacting surfaces of the parts, the generated frictional heat producing softened adjacent regions in the first and second parts. A force is applied to the first and second parts to plastically deform the softened adjacent regions and to forge together the first and second parts to form a solid-state joint. A composite torsional damper hub assembly includes a steel stem and a damper hub welded to the stem at an interface. The damper hub is formed of aluminum or an aluminum alloy, and the interface is generally frustoconical.

### TECHNICAL FIELD

The technical field of this disclosure relates generally to friction welding of dissimilar materials and to torsional dampers.

### INTRODUCTION

Automobile engines produce torsional vibrations, due to the firing of the pistons, that are undesirable to transmit through the vehicle transmission. To isolate such torsional vibrations, torsional dampers can be implemented.

A torsional damper typically includes a torsional damper hub made of nodular cast iron or steel and having a stem coupled to the crankshaft and a spoked hub portion attached to a torsional ring via a damping material. While good for strength, iron or steel components add significant weight to vehicles. It would be desirable to form certain components from aluminum except in areas where steel is more desirable for strength, but it has been difficult to join steel and aluminum. For example, poor bonding along with excessive deformation of aluminum has prevented friction welding from being a viable process for joining a steel damper stem to a proposed aluminum hub portion.

### SUMMARY

The present disclosure provides a way to soundly friction weld steel parts to aluminum parts, such as a steel stem to an aluminum torsional damper hub. The steel and aluminum parts are joined at angled surfaces, or inclined surfaces, which are disposed at acute angles with respect to the pressure axis along which the friction welding occurs, which is also the longitudinal axis and rotational axis of the steel stem. Grooves may also be formed into the contacting surface of the steel part to provide greater current density on the steel side, resulting in an aluminum-steel weld joint that fuses the materials together without excessively melting the aluminum part and excessively forming brittle intermetallic materials.

In one form, which may be combined with or separate from the other forms disclosed herein, a method of joining components formed of dissimilar materials is provided. The method includes providing a metallic first part defining a first part contacting surface having a frustoconical shape and providing a metallic second part defining a second part contacting surface, where the first and second parts are formed of dissimilar materials. The method includes bringing the first and second parts into contact with one another, and rotating one of the first and second parts while the other of the first and second parts remains stationary, so as to generate frictional heat between the first and second part contacting surfaces, the generated frictional heat producing adjacent softened regions in the first and second part contacting surfaces. The method further includes applying a force to the first and second parts along a pressure axis to plastically deform the softened regions and to forge together the first and second part contacting surfaces to form a solid-state joint upon cooling and hardening of the softened regions.

In another form, which may be combined with or separate from the other forms provided herein, a composite torsional damper assembly is provided that includes a steel stem defining a longitudinal axis therealong. A damper hub is welded to the stem at an interface between the damper hub and the stem. The damper hub is formed of aluminum or an aluminum alloy, and the interface is generally frustoconical.

Additional features may be provided, including but not limited to the following: the first part contacting surface having a cross-sectional edge disposed at an angle with respect to the pressure axis; the angle being in the range of 30 degrees to 85 degrees; or more preferably, the angle being in the range of 60 to 85 degrees; the first part being formed of at least a majority of steel; the second part being formed of aluminum or an aluminum alloy; preheating the first part to a temperature between 200 and 700 degrees Celsius prior to bringing the first and second parts into contact with one another; providing the first part as a stem and the second part as a damper hub; the step of preheating including induction heating the first part contacting surface; wherein the first part contacting surface has a temperature between 200° C. and the solidus of the second part material e.g. 580° C. when brought into contact with the second part contacting surface; wherein the stem is rotated and the damper hub is held stationary; one of the first and second part contacting surfaces defining a plurality of grooves therein; wherein the plurality of grooves are separated by a plurality of raised portions; wherein the plurality of grooves are defined in the first part contacting surface; wherein each groove is defined having a curved shape in the first part contacting surface starting at an inner annular surface of the first part and extending radially outward from the inner annular surface; providing a coating disposed on the first part contacting surface; the coating being a copper alloy comprised of at least 50 weight percent copper; the steel including carbon at a weight percent no greater than 0.33; the second part or damper hub being formed of at least one of the following: a) a cast aluminum alloy comprising at least one of silicon, magnesium, copper, and manganese, and b) a wrought aluminum alloy comprising at least one of zinc and silicon; the interface between the stem and the damper hub having a cross-sectional edge disposed at an angle with respect to the longitudinal axis, the angle being in the range of 30 to 85 degrees or 60 to 85 degrees; an interface material disposed along the interface; the interface material being formed of a majority of copper; and the coating or interface material consisting essentially of 50-70 weight percent copper, 0-30 weight percent nickel, 0-10 weight percent aluminum, 0-10 weight percent iron, 0-8 weight percent manganese, 0-10 weight percent silicon, 0.1-0.5 weight percent titanium, and 0-0.5 weight percent trace elements.

The above and other advantages and features will become apparent to those skilled in the art from the following detailed description and accompanying drawings.

### BRIEF DESCRIPTION OF THE DRAWINGS

The drawings described herein are for illustration purposes only and are not intended to limit the scope of the present disclosure in any way.

FIG. 1A is a perspective view of a torsional damper having a composite torsional damper hub assembly, in accordance with the principles of the present disclosure;

FIG. 1B is a cross-sectional view of the torsional damper of FIG. 1A, taken along the lines 1B-1B, according to the principles of the present disclosure;

FIG. 1C is a cross-sectional view of a composite torsional damper hub assembly of the torsional damper of FIGS. 1A-1B, in accordance with the principles of the present disclosure;

FIG. 2 is a block diagram illustrating a method of joining components formed of dissimilar materials, such as components of the torsional damper hub assembly of FIG. 1C, according to the principles of the present disclosure;

FIG. 3 is a cross-sectional view illustrating components of the composite torsional damper hub assembly of FIG. 1C, prior to assembly of the components, including a stem and a damper hub, in accordance with the principles of the present disclosure;

FIG. 4 is an end view of the stem of FIG. 3, according to the principles of the present disclosure; and

FIG. 5 is a cross-sectional view illustrating components of another variation of the composite torsional damper hub assembly, in accordance with the principles of the present disclosure.

### DETAILED DESCRIPTION

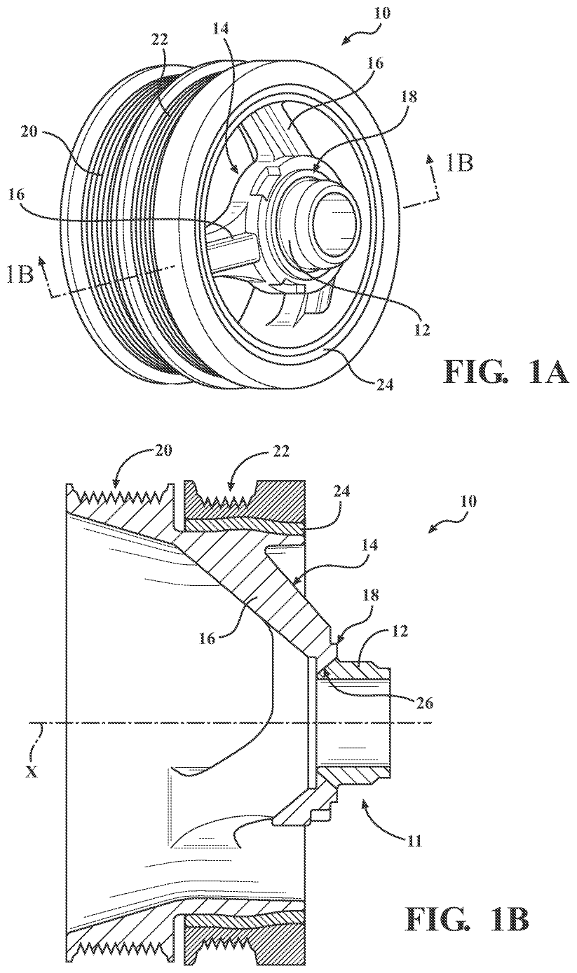

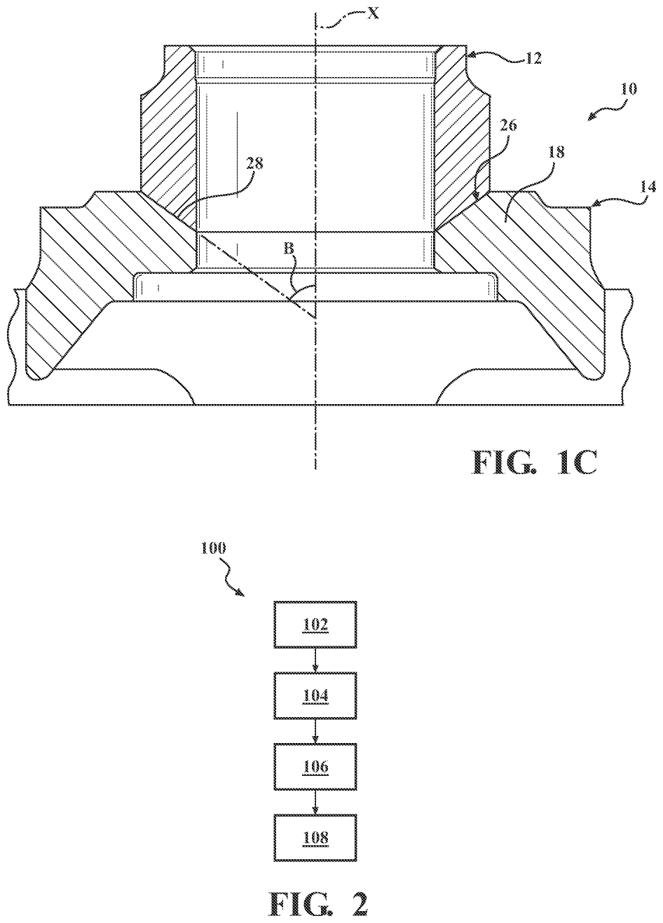

Referring now to FIGS. 1A-1C, a torsional damper is illustrated and generally designated at 10. The torsional damper 10 has a composite torsional damper hub assembly 11 that includes an annular stem 12 and an annular damper hub 14. The stem 12 is configured to be coupled to the engine crankshaft (not shown). The stem 12 is joined with the damper hub 14, which may have a plurality of spokes 16 extending from an end 18 connected to the stem 12 and to a hub end 20, where the hub end 20 has a larger diameter than the diameter of the stem 12 and the end 18. The damper hub 14 is attached to an inertia ring 22 via a damping material 24, for example, EPDM elastomer, which absorbs torsional vibrations from the crankshaft.

The stem 12 and damper hub 14 are joined at an angled interface 26. The stem 12 defines a longitudinal axis X along its center. The damper hub 14 is welded to the stem 12 at the interface 26. The interface 26 is generally frustoconical in shape. Thus, the interface 26 between the stem 12 and the damper hub 14 has a cross-sectional edge 28 disposed at an angle B with respect to the longitudinal axis X. The angle B is in the range of 30 degrees to 85 degrees, or more preferably, in the range of 60 to 85 degrees.

The stem 12 is made of steel, which provides good strength for the keyway (not shown) for connecting the stem 12 to the crankshaft of the engine (not shown). The steel is preferably a low to medium carbon steel with good weldability, for example, having a carbon weight percent no greater than 0.33. Thus, the steel used may be a plain carbon steel or an HSLA steel, in as-supplied or non-heat-treated condition. The steel preferably has an ultimate tensile strength in the range of 450-650 MPa, for advantageous function, performance, cost, and manufacturability. Particular carbon steels that may be used include SAE 1020-1030 having 0.18-0.33 weight percent carbon, 0.3-0.9 weight percent manganese, 0.1-0.35 weight percent silicon, a maximum of 0.04 weight percent phosphorus, and a maximum of 0.05 weight percent sulfur. HLSA steels that may be used include SAE J2340 380X to 550Y, with a maximum of 0.13 weight percent carbon, a maximum of 0.06 weight percent phosphorus, a maximum of 0.015 weight percent sulfur, and one or multiple alloying elements such as vanadium, titanium, niobium at a minimum of 0.005 weight percent.

The steel used can be any plain low or medium carbon steels such as 1022, 1023, 1025 and 1026 alloys. For example, the stem 12 may be formed of: a 1022 steel alloy having 0.18-0.23 weight percent carbon, 0.70-1.00 weight percent manganese, a maximum of 0.040 weight percent phosphorus, and a maximum of 0.050 weight percent sulfur; a 1023 steel alloy having 0.20-0.25 weight percent carbon, 0.30-0.60 weight percent manganese, a maximum of 0.040 weight percent phosphorus, and a maximum of 0.050 weight percent sulfur; a 1025 steel alloy having 0.22-0.28 weight percent carbon, 0.30-0.60 weight percent manganese, a maximum of 0.040 weight percent phosphorus, and a maximum of 0.050 weight percent sulfur; or a 1026 steel alloy having 0.22-0.28 weight percent carbon, 0.60-0.90 weight percent manganese, a maximum of 0.040 weight percent phosphorus, and a maximum of 0.050 weight percent sulfur.

By way of example, the damper hub 14 may be formed of one or more of the following: a) a cast aluminum alloy comprising at least silicon, magnesium, copper, and manganese; and b) a wrought aluminum alloy comprising at least one of zinc and silicon. For example, cast aluminum alloys that may be used include aluminum-silicon based alloys (for example, 356/357 Al alloys), such as those that consist essentially of: 0.5-12 weight percent silicon, 0.05-0.6 weight percent magnesium, 0.1-4.5 weight percent copper, 0.1-2 weight percent iron, 0.05-2 weight percent manganese, 0-0.5 weight percent other trace elements, and the balance aluminum. Other cast aluminum alloys that may be used include aluminum-copper based alloys (for example, 206 Al alloys), such as those that consist essentially of: 0.5-10 weight percent copper, 0.1-2 weight percent manganese, 0.1-1 weight percent magnesium, 0-0.5 weight percent other trace elements, and the balance aluminum.

Wrought aluminum alloys that may be used include aluminum-copper based alloys (for example, 2014 Al alloys), such as those that consist essentially of: 4-5 weight percent copper, 0.5-1 weight percent silicon, 0.4-0.5 weight percent magnesium, 0.5-0.6 weight percent manganese, a maximum of 0.1 weight percent chromium, and the balance aluminum. Other wrought aluminum alloys that may be used include aluminum-silicon-magnesium based alloys (for example, 6061 Al alloys), such as those that consist essentially of: 0.2-1 weight percent silicon, 0.4-1 weight percent magnesium, 0.01-0.5 weight percent chromium, 0-1 weight percent iron, 0-0.5 weight percent other trace elements, and the balance aluminum. Additional other wrought aluminum alloys that may be used include aluminum-silicon based alloys (for example, 4000 Al alloys), such as those that consist essentially of: 5-6 weight percent silicon, 0-0.8 weight percent iron, 0-0.3 weight percent copper, a maximum of 0.2 weight percent zinc, a maximum of 0.15 weight percent manganese, a maximum of 0.1 weight percent magnesium, a maximum of 0.1 weight percent other trace elements, and the balance aluminum. Further additional other wrought aluminum alloys that may be used include aluminum-zinc-magnesium based alloys (for example, 7000 Al alloys), such as those that consist essentially of: 4-6 weight percent zinc, 2-2.5 weight percent magnesium, 1-2 weight percent copper, and a maximum of 0.5 weight percent silicon, manganese, titanium, chromium, and other trace elements, and the balance aluminum.

Optionally, an interface material may be disposed along the interface 26. For example, the interface material may be applied to the steel stem 12 as a coating prior to attachment of the stem 12 to the hub 14. The interface material is formed of at least 50 weight percent copper. For example, the interface material may consist essentially of: 50-70 weight percent copper, 0-30 weight percent nickel, 0-10 weight percent aluminum, 0-10 weight percent iron, 0-8 weight percent manganese, 0-10 weight percent silicon, and 0.1-0.5 weight percent titanium. In one example, the interface material may consist essentially of about 60 weight percent copper, about 25 weight percent nickel, about 5 weight percent aluminum, about 5 weight percent iron, about 5 weight percent manganese, about 0.35 weight percent titanium, and other trace elements up to, for example, 0.5 weight percent.

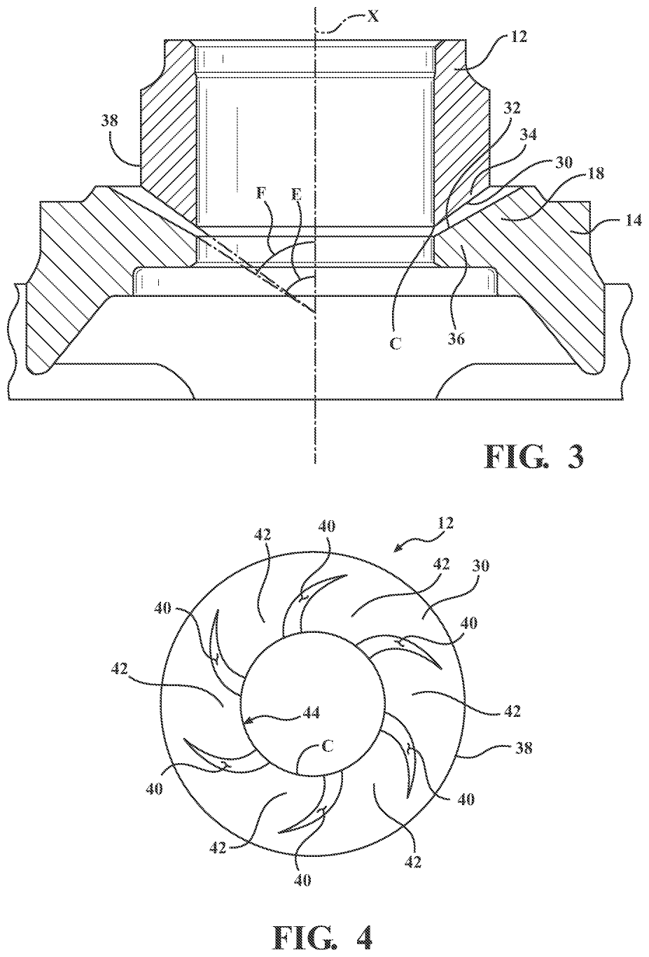

Referring now to FIGS. 2 and 3, a method of joining components is illustrated in block diagram form (FIG. 2), with the components shown prior to assembly (FIG. 3). The components to be joined are illustrated as the stem 12 and damper hub 14 of the composite torsional damper hub assembly 11 described above, but the method 100 could apply to other components formed of dissimilar metal materials, as well.

The method 100 includes a step 102 of providing a metallic first part (e.g., stem 12) defining a first part contacting surface 30 having a frustoconical shape. The method 100 also includes a step 104 of providing a metallic second part (e.g., damper hub 14) defining a second part contacting surface 32. The first and second parts 12, 14 are formed of dissimilar materials, such as the aluminum/aluminum alloys and steel materials described above. For clarification, step 102 need not be performed before step 104.

To establish the solid-state joint between the steel stem 12 and the aluminum or aluminum alloy damper hub 14, these two dissimilar material components may be friction welded together. Thus, the method 100 includes a step 106 of bringing the first and second parts 12, 14 into contact with one another, and rotating one of the first and second parts 12, 14 while the other of the first and second parts 12, 14 remains stationary, so as to generate frictional heat between the first and second part contacting surfaces 30, 32. The generated frictional heat produces softened adjacent regions 34, 36 in the first and second part contacting surfaces 30, 32 when one of the parts 12, 14 is being rotated and the contacting surfaces 30, 32 are in contact with one another. In the illustrated example, the steel stem 12 is rotated while the aluminum part 14 is held stationary, but if desired, the aluminum part 14 could alternatively or also be rotated.

After the rotating step 106, and halting rotation of the rotating component, pressure is immediately applied to the contacting surfaces 30, 32 of the two components 12, 14 to essentially forge together the annular steel stem 12 and the annular damper hub 14. Thus, the method 100 includes a step 108 of applying a force to the first and second parts 12, 14 along a pressure axis (the pressure axis is the same as the longitudinal axis X, which is also the axis of rotation of the stem 12, in the illustrated example) to plastically deform the softened adjacent regions 34, 36 and to forge together the first and second part contacting surfaces 30, 32 to form a solid-state joint upon cooling and hardening of the softened adjacent regions 34, 36.

The friction welding process may involve pre-heating the first part 12 to a temperature between 200 and 700 degrees Celsius prior to bringing the first and second parts 12, 14 into contact with one another. If the first part 12 is heated above the aluminum alloy solidus e.g. 580 degrees C. to retain a high preheating enthalpy, the first part 12 is preferably cooled to the solidus e.g. 580 degrees C. or below prior to bringing the first part 12 into contact with the second part 14, but in other cases, the first part 12 could have a temperature up to 700 degrees C. when brought into contact with the second part 14. The step of preheating may include induction heating the first part contacting surface 30, and the first part contacting surface 30 preferably has a temperature between 200° C. and aluminum alloy solidus e.g. 580° C. when brought into contact with the second part contacting surface 32.

Friction welding, as used herein to join the first and second components 12, 14, is a solid-state joining operation in which two metal components—one of which is held stationary while the other is rotated—experience relative contacting rotational movement between contacting portions of the components to generate frictional heat. The generated heat softens one or both of the components 12, 14 so that an applied pressure or upset force can plastically displace material from one or both of the components 12, 14 to forge the two contacting portions together and compel the atomic interdispersion that typifies the solid-state joint. The friction welding process applicable here may include at least a pre-heating step, a friction heating step, and a pressure application step.

In the optional pre-heating step, an outer annular surface 38 of the steel stem 12 is heated in preparation for joining. The outer annular surface 38 of the annular steel stem 12 may be heated by induction heating to a temperature above 200° C. or, more specifically, between 200° C. and 700° C. or preferably between 200° C. and the solidus of the aluminum alloy. This may involve placing an induction coil (not shown), such as an electromagnetic copper coil, adjacent to or around the outer annular surface 38 of the steel stem 12, and then passing a high-frequency AC current provided by a radio-frequency (RF) power supply through the induction coil. The passage of the AC current through the induction coil creates an alternating magnetic field that penetrates the annular steel stem 12 and generates eddy currents that resistively heat the stem 12 together with some additional heating through magnetic hysteresis.

While the contacting surface 30 of the stem 12 is still at an elevated temperature between 200° C. and 700° C. (or between 200° C. and aluminum alloy solidus e.g. 580° C., in some examples), the step 106 of rotating the stem 12 while bringing the stem 12 into contact with the hub 14 is performed. In the friction step 106, the pre-heated annular frustoconical contacting surface 30 of the steel stem 12 is located adjacent to and at least partially in contact with the annular contacting surface 32 of the damper hub 14, which has a frustoconical inner surface. The contacting surface 32 of the damper hub 14 eventually becomes fully or partially integrated into the solid-state joint between the stem 12 and the hub 14, and the stem 12 and the hub 14 are forged together.

Once contact has been established between the contacting surface 30 of the stem 12 and the contacting surface 32 of the damper hub 14, one of stem 12 and the damper hub 14 is rotated, while the other of the stem 12 and the damper hub 14 is held stationary. The relative contacting rotational movement experienced between the contacting surface 30 of the annular stem 12 and the contacting surface 32 of the annular damper hub 14 generates frictional heat between those surfaces 30, 32. This frictionally-generated heat softens adjacent regions 34, 36 of the stem 12 and the damper hub 14. Timely softening of the adjacent regions 34, 36 is aided through the advanced heating of the stem 12.

Either of the stem 12 and the damper hub 14 can be fixtured and rotated relative to the other. For example, in a preferred example, the damper hub 14 is held stationary and the stem 12 is rotated. To that end, the damper hub 14 may be lowered onto a support block (not shown), and the stem 12 may be fixedly braced or clamped to an annular retention member (not shown), which in turn is mounted to a rigid spindle. The preheating step may be practiced while the stem 12 is installed on the spindle to prevent substantial heat loss during the time that elapses between the preheating and friction heating steps. Eventually, the steel stem 12 is moved toward the aluminum damper hub 14 until a portion of the annular contacting surface 30 of the stem 12 and a portion of the annular contacting surface 32 of the damper hub 14 are in axially aligned contact. At that point, rotation of the spindle may be commenced, which causes the desired relative contacting rotational movement between the contacting surface 30 of the stem 12 and the contacting surface 32 of the damper hub 14. The speed and duration of spindle rotation is controlled to achieve the requisite softened adjacent regions 34, 36.

After the adjacent regions 34, 36 have softened through relative rotational frictional contact, the pressure application step 108 is performed. In this step 108, the stem 12 and the hub 14 are pressed together under an applied force. The contacting surfaces 30, 32 are pressed together with enough force to cause plastic deformation of the compressed softened adjacent regions 34, 36 to forge together the contacting surfaces 30, 32. The applied force may be administered by pressing the stem 12 and the damper hub 14 together along the pressure axis X, preferably hydraulically, in opposition to a resisting force of the parts 12, 14. This inward pressing force may be applied simultaneously around the entire annular contacting surfaces 30, 32, or in a variation, may be applied in multiple places along the inner circumference C of the stem 12.

During the pressure application step 108, and possibly for a short time afterward, the softened adjacent regions 34, 36, which are now plastically deformed, cool and harden into a solid-state joint. A composite torsional damper hub assembly 11 is now formed and can be removed from the friction welding tooling. Additional processing of the composite torsional damper hub assembly 11 may be performed at this time. For example, any metal flash that may have resulted from compressing and plastically deforming of the adjacent regions 34, 36 may be removed. Such flash removal can be done in any of a variety of ways including shearing, machining, or grinding, to name but a few options. As another example, exposed areas of the composite torsional damper hub assembly 11 may be hardened, treated by stress relief, annealed, or coated.

The friction welding process described above is subject to a number of possible variations. Most notably, when practicing the friction heating step, the steel stem 12 can be held stationary while the aluminum damper hub 14 is rotated. To perform the friction heating step in this way, the steel stem 12 would be held tightly against the support block by clamps or other retaining equipment, and the aluminum alloy damper hub 14 would be mounted onto the rotatable spindle. Additionally, as part of the preheating step, another heating technique beside induction heating, such as resistive heating, may be performed to heat the steel part 12. Furthermore, the parts 12, 14 may be cleaned prior to the preheating step.

As explained above, the interface 26 between the first and second parts is generally frustoconical in shape. Thus, the first part contacting surface 30 is frustoconical, and the second part contacting surface 32 defines an inner frustoconical surface. Prior to assembly of the first part 12 and the second part 14, as shown in FIG. 3, the stem contacting surface 30 has a cross-sectional edge disposed at the angle E with respect to the longitudinal axis X. The angle E is in the range of 30 degrees to 85 degrees, or more preferably, in the range of 60 to 85 degrees. Thus, the first part contacting surface 30 is inclined with respect to the longitudinal axis X (or pressure axis X, which is also the rotational axis of the rotating part 12).

Similarly, the second part contacting surface 32 is inclined with respect to the pressure axis X. The second part contacting surface 32 is disposed at an angle F with respect to the pressure axis X. The angle F is in the range of 30 degrees to 85 degrees, or more preferably, in the range of 60 to 85 degrees. With reference to FIG. 3, the angles E and F are not necessarily equal to one another prior to the joining of the first and second parts 12, 14. Rather, the angle F may be a bit larger than the angle E, such as 1-10 degrees larger than the angle E, prior to the joining. As the parts 12, 14 are pressed into one another, and where F>E, the inner circumference C of the stem 12 is pressed into the damper hub 14 first for advantageous heat control during the friction welding process. After the parts 12, 14 are joined, the resultant angle B between the first and second parts 12, 14 (which is the edge of the solid-state joint formed between the parts 12, 14) may be a bit larger than the initial angle E between the first part contacting surface 30 and the longitudinal axis X. In some examples, B>E+5 degrees. Providing the inclination angle E of the first part 12 as initially larger than the inclination angle F of the second part 14 (as shown in FIG. 3) allows the area between the contacting surfaces 30, 32 to be increased as the first and second parts 12, 14 are pressed and forged together during the pressure application step 108. Thus, the solid-state joint has a cross-sectional edge being disposed at the angle B with respect to the pressure axis X.

Disposing the contacting surface 30, 32 at angles E, F with respect to the pressure axis X allows the formation of intermetallic materials to be reduced due to shear stresses. When the formation of intermetallic materials is reduced, the weld joint is stronger because it has fewer intermetallics that cause brittleness.

Referring now to FIG. 4, one of the first and second part contacting surfaces 30, 32 may be provided as defining a plurality of grooves 40 therein, where the plurality of grooves 40 are separated by a plurality of raised portions 42. In the illustrated example, the plurality of grooves 40 are defined in the first part contacting surface 30 of the steel stem 12.

In this example, each groove 40 is defined having a curved shape in the first part contacting surface 30 starting at an inner annular surface 44 of the first part 12, at its inner periphery C, and extending radially outward from the inner annular surface 44 toward the outer annular surface 38 of the stem 12. It should be understood, however, that the grooves could be formed having other configurations, such as extending at straight lines radially outward from the inner surface 44, either normal to the inner periphery C, or at acute angles with respect to the inner periphery C. By providing a plurality of grooves 40 separated by raised portions 42 in the steel contacting surface 30, the current density is concentrated in the steel to create hot spots in the steel part 12, and excessive melting of the aluminum part 14 is reduced or eliminated.

In some variations, a coating may be applied to one of the contacting surfaces 30, 32 prior to joining the parts 12, 14 together. For example, a coating may be applied to the steel part contacting surface 30. The coating may be a copper alloy comprised of at least 50 weight percent copper. In one example, the coating may consist essentially of: 50-70 weight percent copper, 0-30 weight percent nickel, 0-10 weight percent aluminum, 0-10 weight percent iron, 0-8 weight percent manganese, 0-10 weight percent silicon, 0.1-0.5 weight percent titanium, and up to 0.5 weight percent trace elements. Thus, the interface 26 may include an interface layer formed of the coating material.

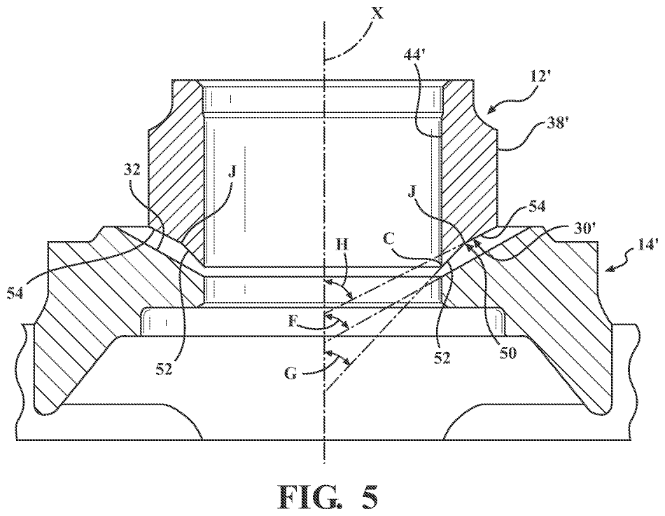

Referring now to FIG. 5, another variation of the initial components 12′, 14′ prior to joining to form a composite torsional damper hub assembly are illustrated. It should be understood that the components 12′, 14′ shown in FIG. 5 may be the same as the components 12, 14 described above, except where described as being different. In the example of FIG. 5, the second part contacting surface 32′ is inclined with respect to the pressure axis X at an angle F, like the second part contacting surface 32 described previously. The angle F is in the range of 30 degrees to 85 degrees, or more preferably, in the range of 60 to 85 degrees, as described above. In FIG. 5, the angle F is shown with respect to the inner surface 44′ of the stem 12′, which has a cross-sectional edge parallel to the axis X.

However, the first part contacting surface 30′ in FIG. 5 is different than the variation of FIG. 3, because the first part contacting surface 30′ has a stepped feature 50 to add further gradual forging of the contacting surfaces 30′, 32′. To this end, the first part contacting surface 30′ defines two frustoconical surfaces 52, 54 joined at an annular edge J, where the inner frustoconical surface 52 extends from the inner surface 44′ of the annular stem 12′ to the edge J, and the outer frustoconical surface 54 extends from the edge J to the outer annular surface 38′ of the stem 12′. The inner frustoconical surface 52 is disposed at an angle G with respect to the longitudinal axis X (which runs cross-sectionally parallel) to the inner edge 44′. Due to the stepped feature 50 at the edge J, the outer frustoconical surface 54 is disposed at an angle H with respect to the longitudinal axis X and to the inner edge 44′. The angle G may be smaller than the angle H and the angle F, as shown. The angles F and H may be equal, if desired, with the angle G being 5-15 degrees smaller than the angles F and H.

The detailed description and the drawings or figures are supportive and descriptive of the many aspects of the present disclosure. The elements described herein may be combined or swapped between the various examples. While certain aspects have been described in detail, various alternative aspects exist for practicing the invention as defined in the appended claims. The present disclosure is exemplary only, and the invention is defined solely by the appended claims.

What is claimed is:

1. A method of joining components formed of dissimilar materials, the method comprising:
providing a metallic first part defining a first part contacting surface having a frustoconical shape;
providing a metallic second part defining a second part contacting surface, the first and second parts being formed of dissimilar materials;
bringing the first and second part contacting surfaces into contact with one another, and rotating one of the first and second parts while the other of the first and second parts remains stationary, so as to generate frictional heat between the first and second part contacting surfaces, the generated frictional heat producing softened adjacent regions in the first and second parts; and
applying a force to the first and second parts along a pressure axis to plastically deform the softened adjacent regions and to forge together the first and second part contacting surfaces to form a solid-state joint upon cooling and hardening of the adjacent regions.

2. The method of claim 1, the first part contacting surface having a cross-sectional edge disposed at an angle with respect to the pressure axis, the angle being in the range of 30 degrees to 85 degrees.

3. The method of claim 2, further comprising providing the first part as being formed of at least a majority of steel and providing the second part as being formed of one of aluminum and an aluminum alloy.

4. The method of claim 3, further comprising preheating the first part to a temperature between 200 and 700 degrees Celsius prior to bringing the first and second part contacting surfaces into contact with one another.

5. The method of claim 4, further comprising providing the first part as a stem and the second part as a damper hub.

6. The method of claim 5, the step of preheating including induction heating the first part contacting surface, and wherein the first part contacting surface has a temperature between 200° C. and 700° C. when brought into contact with the second part contacting surface.

7. The method of claim 5, wherein the stem is rotated and the damper hub is held stationary.

8. The method of claim 1, further comprising providing one of the first and second part contacting surfaces as defining a plurality of grooves therein, wherein the plurality of grooves is separated by a plurality of raised portions.

9. The method of claim 8, wherein the plurality of grooves is defined in the first part contacting surface.

10. The method of claim 9, wherein each groove of the plurality grooves is defined having a curved shape in the first part contacting surface starting at an inner annular surface of the first part and extending radially outward from the inner annular surface.

11. The method of 1, further comprising providing a coating disposed on the first part contacting surface, the coating being a copper alloy comprised of at least 50 weight percent copper.

12. The method of claim 11, further comprising providing the coating consisting essentially of:
50-70 weight percent copper;
0-30 weight percent nickel;
0-10 weight percent aluminum;
0-10 weight percent iron;
0-8 weight percent manganese;
0-10 weight percent silicon;
0.1-0.5 weight percent titanium; and
a maximum of 0.5 weight percent trace elements.

13. The method of claim 2, the angle being in the range of 60 to 85 degrees.

14. The method of claim 3, the steel including carbon at a weight percent no greater than 0.33, and the second part being formed of at least one of the following:
a) a cast aluminum alloy comprising at least one of silicon, magnesium, copper, and manganese; and
b) a wrought aluminum alloy comprising at least one of zinc and silicon.

15. The method of claim 2, the angle being a first angle, the cross-sectional edge being a first cross-sectional edge, the second part contacting surface having a second cross-sectional edge disposed at a second angle with respect to the pressure axis, the second angle being in a range of 1 to 10 degrees larger than the first angle, the solid-state joint having a third cross-sectional edge being disposed at a third angle with respect to the pressure axis, the third angle being larger than the first angle.

16. A composite torsional damper hub assembly comprising:
a steel stem defining a longitudinal axis therealong; and
a damper hub welded to the stem at an interface between the damper hub and the stem, the damper hub being formed of one of aluminum and an aluminum alloy, the interface being generally frustoconical.

17. The composite torsional damper hub assembly of claim 16, the interface between the stem and the damper hub having a cross-sectional edge disposed at an angle with respect to the longitudinal axis, the angle being in the range of 30 degrees to 85 degrees.

18. The composite torsional damper hub assembly of claim 17, further comprising an interface material disposed along the interface, the interface material being formed of at least 50 weight percent copper.

19. The composite torsional damper hub assembly of claim 18, the interface material consisting essentially of:
50-70 weight percent copper;
0-30 weight percent nickel;
0-10 weight percent aluminum;
0-10 weight percent iron;
0-8 weight percent manganese;
0-10 weight percent silicon;
0.1-0.5 weight percent titanium; and
0-0.5 weight percent trace elements.

20. The composite torsional damper hub assembly of claim 16, the angle being in the range of 60 to 85 degrees, the steel stem including carbon at a weight percent no greater than 0.33, and the damper hub being formed of at least one of the following:
a) a cast aluminum alloy comprising at least one of silicon, magnesium, copper, and manganese; and
b) a wrought aluminum alloy comprising at least one of zinc and silicon.
